(19) United States
(12) Patent Application Publication
(10) Pub. No.: US 2006/0238831 A1
(43) Pub. Date: Oct. 26, 2006

(54) Electrophotographic image forming apparatus and image forming method

(76) Inventor: Se-tae Kim, Suwon-si (KR)

Correspondence Address: STANZIONE & KIM, LLP, 919 18TH STREET, N.W., SUITE 440, WASHINGTON, DC, 20006, US

(21) Appl. No.: 11/311,649

(22) Filed: Dec. 20, 2005

(30) Foreign Application Priority Data
Apr. 20, 2005 (KR) 2005-32730

(51) Int. Cl. H04N 1/23

(52) U.S. Cl. 358/509; 358/302; 358/296

(57) ABSTRACT

An electrophotographic image forming apparatus including a photosensitive drum, a light generator to generate a light to be scanned on the photosensitive drum according to an image signal, an image signal supplier to supply the image signal to the light generator having a predetermined signal amount unit, a synchronous signal generator to generate a synchronous signal based on the light generated by the light generator, a light intensity signal generator to detect the light generated by the light generator and to generate a light intensity signal that corresponds to intensity of the detected light, a difference value calculator to compare the light intensity signal with a reference signal and to calculate a difference value of a signal level thereof, and a controller to control the image signal supplier to supply the image signal to the light generator if it is determined that a predetermined amount of time that corresponds to the difference value has elapsed since a time when the synchronous signal is generated. Thus, the electrophotographic image forming apparatus and an image forming method improves picture quality by compensating for variations in a supply start point of image signals that result from optical power changes.

### CROSS-REFERENCE TO RELATED APPLICATIONS

This application claims the benefit of Korean Patent Application No. 2005-32730, filed on Apr. 20, 2005, in the Korean Intellectual Property Office, the disclosure of which is incorporated herein by reference in its entirety.

### BACKGROUND OF THE INVENTION

1. Field of the Invention

The present general inventive concept relates to an electrophotographic image forming apparatus and an image forming method, and more particularly, to an electrophotographic image forming apparatus and an image forming method which improves image quality by compensating for a variation in a supply of start points of image signals that results from a change in optical power.

An electrophotographic image forming apparatus, such as a laser printer, generates a laser beam, forms a latent image on a photosensitive drum and applies a toner to the formed latent image to transfer an image onto a printing medium. FIG. 1 illustrates a laser scanning unit 10 and an image signal control unit 40 of a conventional electrophotographic image forming apparatus. As illustrated in FIG. 1, the conventional electrophotographic image forming apparatus includes the laser scanning unit (LSU) 10 and the image signal control unit 40. The laser scanning unit 10 has a semiconductor laser diode 12 to generate a laser beam and to scan the generated laser beam on a photosensitive drum 26 at constant linear velocity; a collimating lens 14; a cylinder lens 16; a polygon motor 18; a rotating polygon mirror 20; a lens 22; a reflection mirror 24; a horizontal synchronous mirror 28; and a light sensor 30.

The laser beam emitted from the semiconductor laser diode 12 forms a scanning line on the photosensitive drum 26 by being reflected from the rotating polygon mirror 20. The light sensor 30 receives the laser beam reflected from the horizontal synchronous mirror 28 when starting each injection line (i.e., scanning line) and generates a horizontal synchronous signal which has one pulse per scanning line.

The image signal control unit 40 controls operation of the semiconductor laser diode 12 of the laser scanning unit 10, receives the horizontal synchronous signal from the laser scanning unit 10, counts a predetermined time, and then transmits a predetermined amount unit of image signals to the semiconductor laser diode 12. That is, the image signal control unit 40 performs counting for “N” times (i.e., N predetermined time intervals) based on pulses of the received horizontal synchronous signal, and thereafter, starts outputting the image signal to the semiconductor laser diode 12 based on pulses of the received horizontal synchronous signal. The semiconductor laser diode 12 is driven again by the output image signal, and the scanning operation is then repeated.

Referring to FIGS. 2A to 2C, operation of the conventional electrophotographic image forming apparatus will now be described with respect to a variation in optical power. The light sensor 30 collects the laser beam from the semiconductor laser diode 12 and generates the horizontal synchronous signal. The generation of the horizontal synchronous signal is made when the optical power of the incident laser beam reaches a predetermined threshold level 4. However, a reference voltage, which determines the optical power of the laser beam, may change due to external noise or internal unstable control, thereby possibly instantaneously changing the optical power of the laser beam.

For example, if the optical power of the laser beam incident on the light sensor 30 changes from 2 to 3 as illustrated in FIG. 2A, a time that it takes for the optical power to reach the threshold level 4 of the light sensor 30 also changes, thereby causing a time difference of as much as “t” between horizontal synchronous signals A and B, respectively, generated to correspond thereto. The time difference “t” of the horizontal synchronous signals A and B is reflected in operation of the image signal control unit 40. Thus, a start point of the image signal illustrated in FIG. 2B may also include the time difference “t.” Accordingly, a position difference “d,” which corresponds to the time difference “t,” is generated in a printed image in a left margin as illustrated in FIG. 2C, thereby deteriorating picture quality.

### SUMMARY OF THE INVENTION

An aspect of the present general inventive concept provides an electrophotographic image forming apparatus and an image forming method which compensates for variations in a supply of start point of image signals that results from an optical power change to improve picture quality.

Additional aspects of the present general inventive concept will be set forth in part in the description which follows and, in part, will be obvious from the description, or may be learned by practice of the present general inventive concept.

The foregoing and/or other aspects of the present general inventive concept are achieved by providing an electrophotographic image forming apparatus comprising a photosensitive drum, a light generator to generate a light to be scanned on the photosensitive drum according to an image signal, an image signal supplier to supply the image signal to the light generator having a predetermined signal amount unit, a synchronous signal generator to generate a synchronous signal based on the light generated by the light generator, a light intensity signal generator to detect the light generated by the light generator and to generate a light intensity signal that corresponds to intensity of the detected light, a difference value calculator to compare the light intensity signal with a reference signal and to calculate a difference value of a signal level thereof, and a controller to control the image signal supplier to supply the image signal to the light generator if it is determined that a predetermined amount of time that corresponds to the difference value has elapsed since a time when the synchronous signal is generated.

The difference value calculator may comprise a hold circuit to hold a first voltage level of an initial light intensity signal generated by the light intensity signal generator as a signal level of the reference signal, and a comparison circuit to compare a second voltage level of a current light intensity signal generated by the light intensity signal generator and the first voltage level of the reference signal held in the hold circuit and to output a voltage difference as the difference value.

The controller may determine a count number that corresponds to the difference value to be added or subtracted with respect to a predetermined reference count number to determine whether the predetermined amount of time has elapsed.

The foregoing and/or other aspects of the present general inventive concept are also achieved by providing an image forming method using an electrophotographic image forming apparatus having a photosensitive drum, a light generator to generate a light to be scanned on the photosensitive drum according to an image signal, an image signal supplier to supply the image signal to the light generator having a predetermined signal amount unit, and a synchronous signal generator to generate a synchronous signal based on the light generated by the light generator, the method comprising detecting light generated by the light generator and generating a light intensity signal to correspond to an intensity of the detected light, comparing the light intensity signal with a reference signal to calculate a difference value thereof, and controlling the image signal supplier to supply the image signal to the light generator if it is determined that a predetermined amount of time, which corresponds to the difference value, has elapsed since a time when the synchronous signal is generated.

The difference value may be calculated by holding a first voltage level of an initial light intensity signal generated when the light intensity signal is generated as a signal level of the reference signal, and comparing a second voltage level of a current light intensity signal generated when the light intensity signal is generated and the first voltage level of the held reference signal to output a voltage difference thereof as the difference value.

The controlling of the image signal supplier may comprise determining a count number to correspond to the difference value to be added or subtracted with respect to a predetermined reference count number in predetermined time intervals to determine whether the predetermined amount of time that corresponds to the difference value has elapsed.

The foregoing and/or other aspects of the present general inventive concept are also achieved by providing an image forming apparatus, comprising a laser scanning unit, which comprises a light generating unit to generate one or more scan lines toward a photosensitive drum, an image signal unit to provide an image signal having one or more image signal portions that correspond to the one or more scan lines to the light generating unit such that the light generating unit generates the one or more scan lines accordingly, and a controller to control a time when the image signal unit provides a next portion of the image signal to the light generating unit according to an optical power comparison between a current scan line optical power and a reference optical power.

The foregoing and/or other aspects of the present general inventive concept are also achieved by providing a laser scanning unit usable with an image forming apparatus, the laser scanning unit comprising a light generator to receive a plurality of portions of an image signal and to generate a light beam including a plurality of scan lines associated with the plurality of portions of the image signal toward a photosensitive drum, an image signal supplier to supply the plurality of portions of the image signal to the light generator, a light intensity signal generator to determine an intensity of the light beam by detecting a portion of the light beam emitted by the light generator, and a controller to compare the intensity of the portion of the light beam with a reference intensity signal and to control the image signal supplier to adjust a timing of a next portion of the image signal associated with a next scanning line according to the comparison.

The foregoing and/or other aspects of the present general inventive concept are also achieved by providing a method of forming an image in an image forming apparatus having a laser scanning unit to scan light on a photosensitive drum, the method comprising scanning a light beam toward the photosensitive drum according to an image signal, detecting the light beam to measure an intensity thereof, comparing the measured intensity to a reference intensity to determine an optical power change, and adjusting a start point of a next portion of the image signal according to the optical power change.

The foregoing and/or other aspects of the present general inventive concept are also achieved by providing a computer readable medium containing executable code to form an image in an image forming apparatus having a laser scanning unit to scan light on a photosensitive drum, the medium comprising a first executable code to control a light scanning unit to scan a light beam toward the photosensitive drum according to an image signal, a second executable code to control a sensor to detect the light beam to measure an intensity thereof, a third executable code to compare the measured intensity to a reference intensity to determine an optical power change, and a fourth executable code to adjust a start point of a next portion of the image signal according to the optical power change.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a laser scanning unit and an image signal control unit of a conventional electrophotographic image forming apparatus;

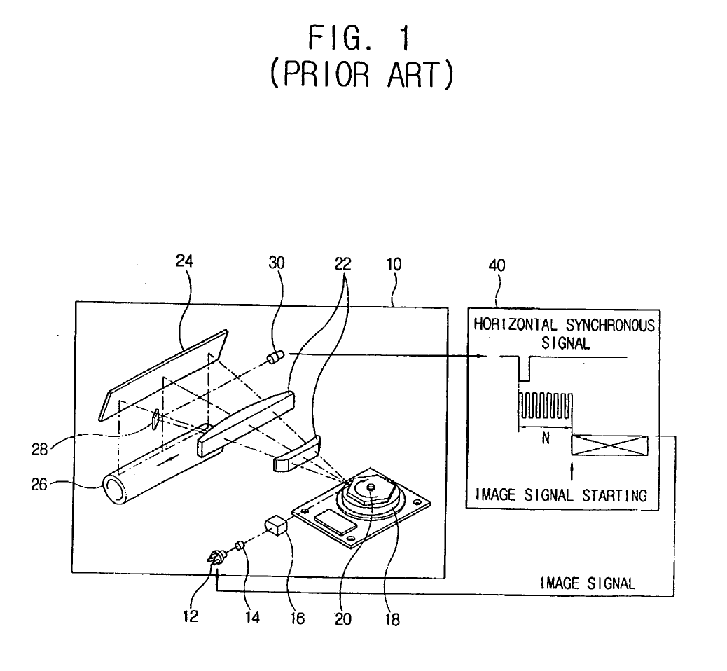

FIGS. 2A to 2C illustrate operation of the conventional electrophotographic image forming apparatus with respect to a variation in optical power;

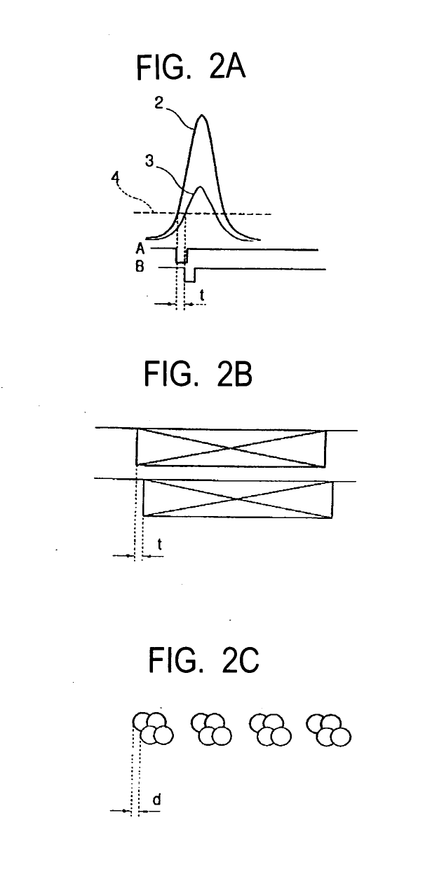

FIG. 3 is a block diagram illustrating an electrophotographic image forming apparatus according to an embodiment of the present general inventive concept;

FIG. 4 is a block diagram illustrating a difference value calculator of the electrophotographic image forming apparatus of FIG. 3;

FIG. 5 illustrates operation of a controller of the electrophotographic image forming apparatus of FIG. 3; and

FIG. 6 is a flowchart schematically illustrating operation of an electrophotographic image forming apparatus according to the embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout.

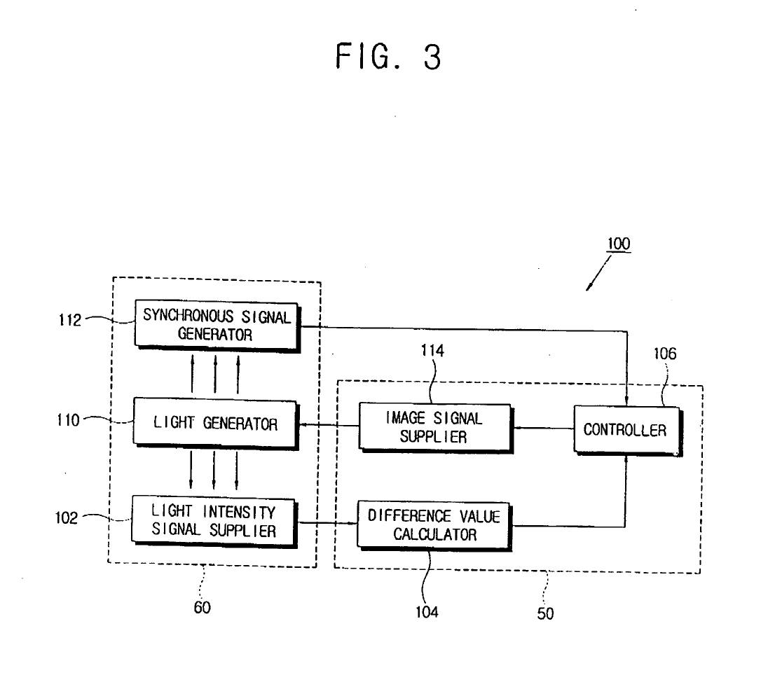

FIG. 3 is a block diagram illustrating an electrophotographic image forming apparatus 100 according to an embodiment of the present general inventive concept. The image forming apparatus 100 generates a laser beam, forms a latent image on a photosensitive drum and applies a toner to the formed latent image to transfer an image to a printing medium. The image forming apparatus 100 may be, for example, a laser printer.

As illustrated in FIG. 3, the image forming apparatus 100 comprises a laser scanning unit 60 to scan a laser beam on the photosensitive drum at a constant linear velocity to form the latent image on the photosensitive drum according to an image signal, and an image signal control unit 50 to supply the image signal to the laser scanning unit 60 and to control the laser scanning unit 60.

The laser scanning unit 60 may comprise a light generator 110 to generate the laser beam. The light generator 110 may be, for example, a semiconductor laser diode. The laser beam emitted from the light generator 110 may form a scanning line on the photosensitive drum according to a reflection from a rotating polygon mirror.

The laser scanning unit 60 may further comprise a synchronous signal generator 112 to generate a synchronous signal based on the laser beam generated by the light generator 110. The synchronous signal generator 112 may be, for example, a light sensor. The synchronous signal generator 112 collects the laser beam reflected from a horizontal synchronous mirror when starting each scanning line to generate the synchronous signal to have one pulse per scanning line. That is, the synchronous signal generator 112 may generate the synchronous signal to have a pulse every time a new scanning line begins. The synchronous signal may be, for example, a horizontal synchronous signal.

The laser scanning unit 60 comprises a light intensity signal supplier 102 to detect the laser beam generated by the light generator 110 and to generate a light intensity signal that corresponds to an intensity of the detected laser beam (i.e., the laser beam detected by the synchronous signal generator 112). The light intensity signal supplier 102 may be, for example, a photodiode.

The image signal control unit 50 may comprise an image signal supplier 114 to supply the image signal having a predetermined signal amount unit that corresponds to one scanning line to the light generator 110. The image signal supplier 114 performs an image processing operation based on a predetermined control signal and supplies the image signal for each scanning line to be stored in a predetermined memory.

The image signal control unit 50 comprises a difference value calculator 104 to compare the light intensity signal of the laser beam provided by the light intensity signal supplier 102 with a reference signal and to calculate a difference value between the light intensity signal and the reference signal. The reference signal may be predetermined. The image signal control unit 50 comprises a controller 106 to control the image signal supplier 114 to produce the image signal to be supplied to the light generator 110 if it is determined that a predetermined amount of time, which corresponds to the difference value between the light intensity signal and the reference signal, has elapsed from a time when the horizontal synchronous signal is generated by the synchronous signal generator 112.

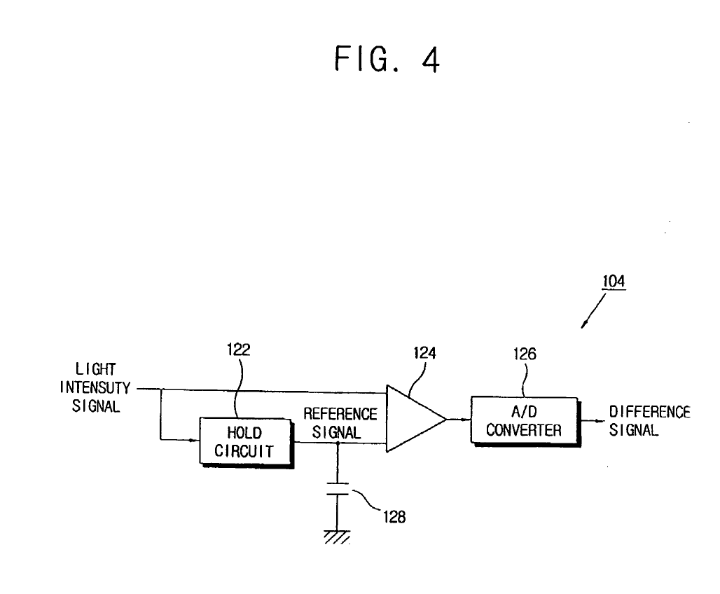

FIG. 4 is a block diagram illustrating the difference value calculator 104 of the electrophotographic image forming apparatus 100. As illustrated in FIG. 4, the difference value calculator 104 may comprise a hold circuit 122 to hold a voltage level of an ith light intensity signal generated by the light intensity signal supplier 102, as a signal level of the reference signal. The “i” may be a natural number, and the ith light intensity signal may correspond to an initial light intensity signal. For example, the hold circuit 122 may hold a voltage level of the light intensity signal generated to correspond to an initial image signal, as the signal level of the reference signal. The hold circuit 122 may be a memory such as, for example, a flip-flop or a register. The difference value calculator 104 may further comprise a capacitor 128 to store the voltage level of the light intensity signal which is held by the hold circuit 122. The difference value calculator 104 may further comprise a comparison circuit 124 to compare an (i+k)th light intensity signal generated by the light intensity signal supplier 102 and the voltage level of the reference signal held in the hold circuit 122. The (i+k)th light intensity signal may correspond to a current light intensity signal. The difference value calculator 104 then outputs the voltage difference between the (i+k)th light intensity signal and the reference signal (i.e., the ith intensity signal) as the difference value. The “k” may also be a natural number. The comparison circuit 124 may compare the currently-generated light intensity signal with the voltage level of the initial light intensity signal held in the hold circuit 122. The comparison circuit 124 may be, for example, a differential amplifier.

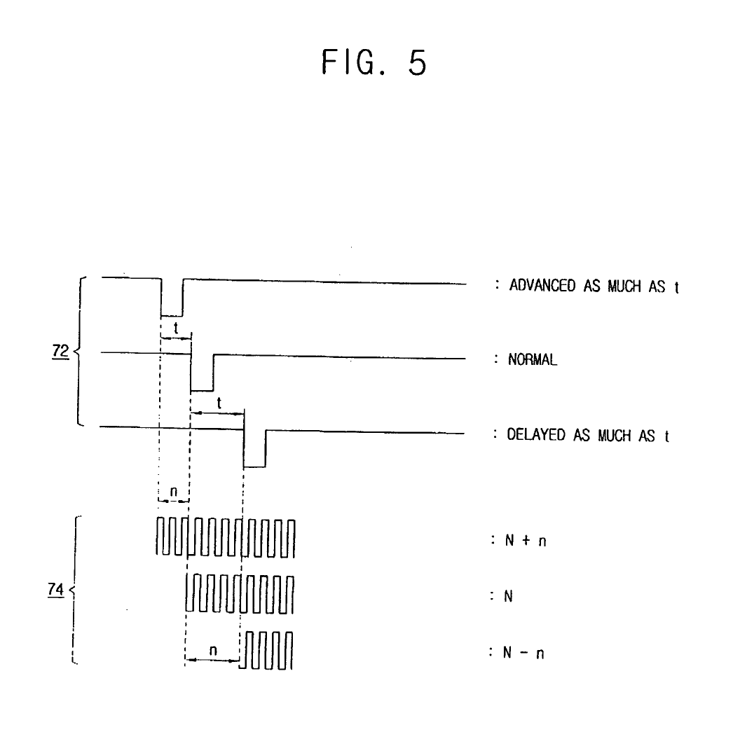

The difference value calculator 104 may further comprise an A/D (analog-to-digital) converter 126 to convert the difference value output by the comparison circuit 124 from an analog voltage signal to a digital voltage signal. The hold circuit 122, the comparison circuit 124, and the A/D converter 126 may receive the horizontal synchronous signal or the image signal to synchronize and operate on the basis thereof. FIG. 5 illustrates operation of the controller 106 of the electrophotographic image forming apparatus 100. As illustrated in FIG. 5, the controller 106 determines a count number “n” that corresponds to the difference value calculated by the difference value calculator 104, and the count number “n” is added or subtracted with respect to a predetermined reference count number “N”, in predetermined time intervals. The controller 106 then determines that the predetermined amount of time is “N+n” or “N−n.” The controller 106 can then determine whether the predetermined amount of time (i.e., “N+n” or “N−n”), which corresponds to the difference value, has elapsed since the synchronous signal was generated by the synchronous signal generator 102.

For example, if optical power increases, as compared to an initial optical power, the input horizontal synchronous signal advances as much as “t” ( see the top signal of the horizontal synchronous signals 72 illustrated in FIG. 5) as compared with a normal signal, which corresponds to the initial signal (see the middle signal of the horizontal synchronous signals 72 illustrated in FIG. 5). The controller 106 then counts the number “N+n” in which the count number “n” that corresponds to the difference value that advances as much as “t” is added to the reference count number “N” (see the top signal of count pulses 74 illustrated in FIG. 5). Thus, by adding the count number “n” to the predetermined reference count number “N” to determine the predetermined amount of time, the controller 106 can synchronize the start point of a current image signal with a start point of an initial image signal. Adding the count number “n” to the predetermined reference count number “N” delays the start point of the current image signal by “t.” This delay compensates for the advance in the current image signal caused by the change in optical power. If the optical power decreases, as compared to the initial optical power, the input horizontal synchronous signal is delayed as much as “t” as compared with the normal signal that corresponds to the initial signal (see the bottom signal of the horizontal synchronous signals 72 illustrated in FIG. 5). The controller 106 then counts “N−n” in which the count number “n” that corresponds to the difference value delayed as much as “t” is subtracted from the reference count number “N” (see the bottom signal of the count pulse 74 illustrated in FIG. 5). Thus, by subtracting the count number “n” from the predetermined reference count number “N” to determine the predetermined amount of time, the controller 106 can synchronize the start point of the current image signal with the start point of the initial image signal. Subtracting the count number “n” from the predetermined reference count number “N” advances the start point of the current image signal by “t.” This advance compensates for the delay in the current image signal caused by the change in optical power.

The count number “n” that corresponds to the difference value between the light intensity signal and the reference signal may be stored in the predetermined memory. The predetermined memory may have a table form. The controller 106 reads the count number “n” that corresponds to an input difference value from the predetermined memory to perform a counting operation if the difference value between the light intensity signal and the reference signal is input.

The controller 106 controls the image signal supplier 114 to supply the image signal to the light generator 110 when the counting operation is completed. If the optical power changes and a possible variation is generated at the supply start point of the image signal, the variation may be compensated for in advance to supply the image signal at constant supply start point.

The controller 106 may be realized as software, hardware, or a combination thereof. The image forming apparatus 100 may comprise a microprocessor, a read only memory (ROM), and a random access memory (RAM). A control program which programs functions of the controller 106 to be adaptable to the microprocessor may be stored in the ROM. The microprocessor may load the control program to the RAM to perform the functions of the controller 106 according to a command of the control program.

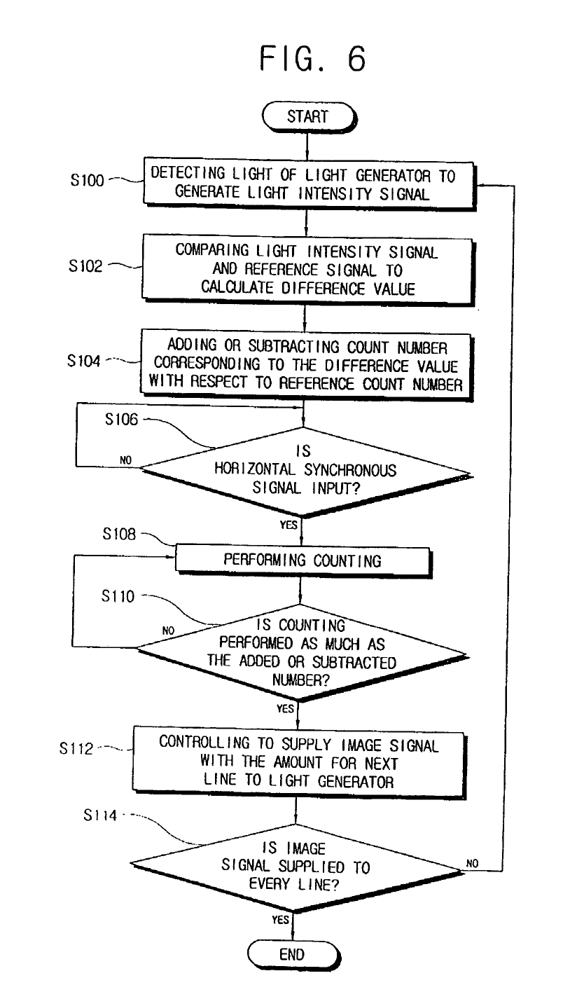

FIG. 6 is a flowchart schematically illustrating a method of operation of an electrophotographic image forming apparatus according to an embodiment of the present general inventive concept. The method of FIG. 6 may be performed by the electrophotographic image forming apparatus 100 of FIG. 3. Accordingly, the method of FIG. 6 will be described with reference to FIGS. 3 through 6. First, the light intensity signal supplier 102 detects the laser beam generated by the light generator 110 to generate the light intensity signal of the detected light beam at operation S100.

The difference value calculator 104 then compares the current light intensity signal with the reference signal, which is preset, to calculate the difference value thereof at operation S102. The controller 106 then adds or subtracts the count number “n” that corresponds to the calculated difference value at operation S104.

The controller 106 determines whether the horizontal synchronous signal is input from the synchronous signal generator 112 at operation S106, and starts the counting operation at operation S108 if it is determined that the horizontal synchronous signal is input (i.e., “Yes” at operation S106). The controller 106 performs the counting operation by counting a number of predetermined pulses that corresponds to the difference value, thereby letting the predetermined amount of time elapse. The controller 106 then determines whether the counting operation has been performed and whether the predetermined amount of time that corresponds to the number of predetermined pulses (i.e., corresponds to the count number “n” added to or subtracted from the reference count number “N”) has elapsed at operation S110. If it is determined that the counting operation is not completed (i.e., “No” at operation S110), the controller 106 continues the count operation at operation S108.

If it is determined that the counting operation is completed (i.e., “Yes” at operation S110), the controller 106 controls the image signal supplier 114 to supply the image signal, which corresponds to a next scanning line, to the light generator 110, at operation S112. The controller 106 then determines whether the image signal that corresponds to all the scan lines has been supplied at operation S114. If it is determined that the image signal that corresponds to all the scan lines has not been supplied at operation S114 (i.e., “No” at operation S114), the operation S100 of generating the light intensity signal through the operation S112 of controlling the image signal supplier 114 are repeated. If it is determined that the image signal for all the scan lines is supplied (i.e., “Yes” at operation S114), the controller 106 determines that the method of FIG. 6 is complete.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic image forming apparatus, comprising:
a photosensitive drum;
a light generator to generate a light to be scanned on the photosensitive drum according to an image signal;
an image signal supplier to supply the image signal having a predetermined signal portion to the light generator;
a synchronous signal generator to generate a synchronous signal based on the light generated by the light generator;
a light intensity signal generator to detect the light generated by the light generator and to generate a light intensity signal that corresponds to intensity of the detected light;
a difference value calculator to calculate a difference value between signal levels of the light intensity signal and a reference signal; and
a controller to control the image signal supplier to supply the image signal to the light generator if it is determined that a predetermined amount of time that corresponds to the difference value has elapsed since a time when the synchronous signal is generated.

2. The electrophotographic image forming apparatus according to claim 1, wherein the difference value calculator comprises:
a hold circuit to hold a first voltage level of an initial light intensity signal generated by the light intensity signal generator as a signal level of the reference signal; and
a comparison circuit to compare a second voltage level of a current light intensity signal generated by the light intensity signal generator and the first voltage level of the reference signal held in the hold circuit and to output a voltage difference as the difference value.

3. The electrophotographic image forming apparatus according to claim 1, wherein the controller determines a count number that corresponds to the difference value to be added or subtracted with respect to a predetermined reference count number to determine whether the predetermined amount of time, which corresponds to the difference value, has elapsed.

4. An image forming apparatus, comprising:
a laser scanning unit, comprising:
a light generating unit to generate one or more scan lines toward a photosensitive drum;
an image signal unit to provide an image signal having one or more image signal portions that correspond to the one or more scan lines to the light generating unit such that the light generating unit generates the one or more scan lines accordingly; and
a controller to control a time when the image signal unit provides a next portion of the image signal to the light generating unit according to an optical power comparison between a current scan line optical power and a reference optical power.

5. The image forming apparatus according to claim 4, wherein the controller advances or delays the next portion of the image signal according to variations of optical power of the one or more scan lines such that each of the one or more image signal portions is supplied to the light generating unit at a constant start point with respect to a predetermined synchronous signal.

6. The image forming apparatus according to claim 4, further comprising:
a synchronous signal generator to generate a synchronous signal having one or more pulses to correspond with a beginning of the one or more scan lines
a sensor to detect the current scan line optical power; and
a difference calculator to calculate a difference between the detected current scan line optical power and the reference optical power and to shift the time when the image signal unit provides a next portion of the image signal to the light generating unit with respect to a pulse of the synchronous signal that corresponds to a next scan line by a number of pulses of a predetermined width, and the number of pulses corresponds to the calculated difference.

7. A laser scanning unit usable with an image forming apparatus, the laser scanning unit comprising:
a light generator to receive a plurality of portions of an image signal to generate a light beam including a plurality of scan lines associated with the plurality of portions of the image signal toward a photosensitive drum;
an image signal supplier to supply the plurality of portions of the image signal to the light generator;
a light intensity signal generator to determine an intensity of the light beam by detecting a portion of the light beam emitted by the light generator; and
a controller to compare the intensity of the portion of the light beam with a reference intensity signal and to control the image signal supplier to adjust a timing of a next portion of the image signal associated with a next scanning line according to the comparison.

8. The laser scanning unit according to claim 7, further comprising:
a synchronous signal generator to generate a synchronous signal during each scan line and to provide the synchronous signal to the controller to indicate when the light generator begins scanning each scan line.

9. The light scanning unit according to claim 7, wherein the controller shifts the timing of the next portion of the image signal of the next scanning line such that a starting point of the next portion of the image signal corresponds to a starting point of the portions of the image signal for each scanning line.

10. The light scanning unit according to claim 7, wherein the controller adjusts the timing of the next portion of the image signal associated with the next scanning line to account for a shift in the next portion of the image signal that results from a change in optical power of the detected portion of the light beam.

11. The light scanning unit according to claim 10, wherein the change in the optical power occurs as a result of a reference voltage change due to noise or instability.

12. The light scanning unit according to claim 7, wherein the controller delays the timing of the next portion of the image signal when an optical power detected by the light intensity signal generator increases, and the controller advances the timing of the next portion of the image signal when the optical power detected by the light intensity signal generator decreases.

13. The light scanning unit according to claim 7, wherein the controller determines a number of predetermined pulses by which to adjust a predetermined pulse count such that the controller adjusts the timing of the next portion of the image signal by the adjusted predetermined pulse count.

14. The light scanning unit according to claim 7, further comprising:
a synchronous signal generator to generate a synchronous signal during each scan line and to provide the synchronous signal to the controller to indicate when the light generator begins scanning each scan line,
wherein the controller controls the image signal supplier to supply the next portion of the image signal a predetermined pulse count after the synchronous signal is generated when the detected portion of the light beam does not change from a current scanning line to the next scanning line, and the controller controls the image signal supplier to supply the next portion of the image signal an adjusted predetermined pulse count after the synchronous signal is generated when the detected portion of the light beam does change from the current scanning line to the next scanning line.

15. The light scanning unit according to claim 7, wherein the controller comprises:
a hold circuit to receive an initial intensity signal and to hold the initial intensity signal as the reference intensity signal;
a comparison circuit to receive the detected intensity of the portion of the light beam and to compare the initial intensity signal with the detected intensity and to generate a difference value; and
a converter to generate an adjustment count proportional to the difference value by which to adjust the timing of the next portion of the image signal.

16. An image forming method usable in an electrophotographic image forming apparatus having a photosensitive drum, a light generator to generate a light to be scanned on the photosensitive drum according to an image signal, an image signal supplier to supply the image signal to the light generator having a predetermined signal portion, and a synchronous signal generator to generate a synchronous signal based on the light generated by the light generator, the method comprising:
detecting light generated by the light generator and generating a light intensity signal to correspond to an intensity of the detected light;
comparing the light intensity signal with a reference signal to calculate a difference value thereof; and
controlling the image signal supplier to supply the image signal to the light generator if it is determined that a predetermined amount of time, which corresponds to the difference value, has elapsed since a time when the synchronous signal is generated.

17. The image forming method according to claim 16, wherein the difference value is calculated by holding a first voltage level of an initial light intensity signal generated when the light intensity signal is generated as a signal level of the reference signal, and comparing a second voltage level of a current light intensity signal generated when the light intensity signal is generated and the first voltage level of the held reference signal to output a voltage difference thereof as the difference value.

18. The image forming method according to claim 16, wherein the controlling of the image signal supplier comprises determining a count number to correspond to the difference value to be added or subtracted with respect to a predetermined reference count number in predetermined time intervals to determine whether the predetermined amount of time that corresponds to the difference value has elapsed.

19. A method of forming an image in an image forming apparatus having a laser scanning unit to scan light on a photosensitive drum, the method comprising:
scanning a light beam toward the photosensitive drum according to an image signal;
detecting the light beam to measure an intensity thereof;
comparing the measured intensity to a reference intensity to determine an optical power change; and
adjusting a start point of a next portion of the image signal according to the optical power change.

20. The method according to claim 19, wherein the detecting of the light beam further comprises generating a synchronous signal in response for each scan line.

21. The method according to claim 20, wherein the adjusting of the start point of the next portion of the image signal comprises allowing a predetermined pulse count to elapse from a time when the synchronous signal is generated when the optical power does not change, and allowing an adjusted predetermined pulse count to elapse from the time when the synchronous signal is generated when the optical power changes.

22. The method according to claim 21, wherein the predetermined pulse count is reduced when the optical power decreases, and the predetermined pulse count is increased when the optical power increases.

23. The method according to claim 21, wherein the predetermined pulse count is adjusted by an amount that is proportional a difference between the measured intensity and the reference intensity.

24. The method according to claim 19, wherein the reference intensity corresponds to an initial intensity, and the measured intensity corresponds to a current intensity.

25. The method according to claim 19, wherein the adjusting of the start point of the next portion of the image signal comprises:
delaying timing of the next portion of the image signal when an optical power detected increases; and
advancing the timing of the next portion of the image signal when the optical power detected decreases.

26. The method according to claim 19, wherein the adjusting of the start point of the next portion of the image signal comprises determining a number of predetermined pulses by which to adjust a predetermined pulse count such that timing of the next image signal is adjusted by the adjusted predetermined pulse count.

27. The method according to claim 19, further comprising:
generating a synchronous signal during each of a plurality of scan lines to indicate when the laser scanning unit begins scanning each scan line,
wherein the next portion of the image signal is supplied a predetermined pulse count after the synchronous signal is generated when the detected light beam does not change from a current scanning line to a next scanning line, and the next portion of the image signal is supplied an adjusted predetermined pulse count after the synchronous signal is generated when the detected light beam does change from the current scanning line to the next scanning line.

28. The method according to claim 19, wherein the adjusting of the start point of the next portion of the image signal comprises:
receiving an initial intensity and holding the initial intensity as the reference intensity;
receiving the measured intensity of the light beam and comparing the initial intensity with the detected intensity and to generate a difference value; and
generating an adjustment count proportional to the difference value by which to adjust timing of the next portion of the image signal.

29. A computer readable medium containing executable code to form an image in an image forming apparatus having a laser scanning unit to scan light on a photosensitive drum, the medium comprising:
a first executable code to control a light scanning unit to scan a light beam toward the photosensitive drum according to an image signal;
a second executable code to control a sensor to detect the light beam to measure an intensity thereof;
a third executable code to compare the measured intensity to a reference intensity to determine an optical power change; and
a fourth executable code to adjust a start point of a next portion of the image signal according to the optical power change.
